(19) United States
(12) Patent Application Publication
(10) Pub. No.: US 2006/0014658 A1
(43) Pub. Date: Jan. 19, 2006

(54) Sodium percarbonate particles with improved storage stability

(75) Inventors: Klaus Zimmermann, Rodenbach (DE); Harald Jakob, Hasselroth (DE); Frank Menzel, Hanau (DE)

Correspondence Address: FITCH, EVEN, TABIN & FLANNERY, P. O. BOX 65973, WASHINGTON, DC, 20035, US

(73) Assignee: Degussa AG, Dusseldorf (DE)

(21) Appl. No.: 11/155,918

(22) Filed: Jun. 16, 2005

Related U.S. Application Data
(63) Continuation of application No. PCT/EP03/14445, filed on Dec. 18, 2003.

(30) Foreign Application Priority Data
Dec. 20, 2002 (DE) 102 61 161.0

(51) Int. Cl. C11D 3/00

(52) U.S. Cl. 510/375

(57) ABSTRACT

The invention is directed to sodium percarbonate particles with improved storage stability. The particles are characterized by the presence of small amounts of hydrophobised finely divided oxides on their surface.

The invention provides sodium percarbonate particles with improved storage stability in the presence of builders, in particular in the presence of siliceous builders.

Sodium percarbonate is used as a bleach and as a bleach-active constituent in detergents and cleansers. Sodium percarbonate has the disadvantage that, in the presence of builders which can take up moisture and then release it again, it tends to decompose, which leads to a loss of active oxygen and thus to a decrease in the bleaching effect. For use in builder-containing bleaches, detergents or cleansers, therefore, sodium percarbonate is preferably used in the form of particles with a stabilising coating in order to produce improved storage stability.

DE 870 092 discloses that sodium percarbonate powder can LU be stabilised by mixing dry with pyrogenic oxides, preferably pyrogenic silica, in amounts of about 1%. The stabilising effect achieved in this way, however, is still not sufficient to avoid the decomposition of sodium percarbonate in mixtures with siliceous builders.

U.S. Pat. No. 4,215,990 describes builder-free bleaches which contain, in addition to 5 to 50 wt. % of sodium percarbonate, 0.1 to 2 wt. % of a finely divided silica with a particle size in the range 1 to 150 μm. To avoid caking, the bleaches also contain 0.05 to 1 wt. % of corn starch and/or diethyl phthalate. The document does not provide any data relating to the use of hydrophobised silica or the stability of the bleaches described in the presence of builders.

WO 92/07057 describes liquid detergent compositions which contain a solid water-soluble peracid compound, a surfactant and a hydrophobic silica. These detergent compositions contain 0.5 to 5 wt. % of the hydrophobic silica as well as the peracid compound in an amount which makes available 0.5 to 3 wt. % of active oxygen. The addition of hydrophobic silica produces a thickening of the liquid detergent composition, from which it is obvious that the hydrophobic silica is present dispersed in the liquid phase of the detergent composition.

U.S. Pat. No. 5,374,368 and U.S. Pat. No. 5,496,542 describe hydrogen peroxide-releasing preparations in the liquid or gel form which contain, in addition to 55 to 90 wt. % of polyalkylene glycol and 5 to 20 wt. % of sodium percarbonate, also 0.5 to 3 wt. % and 0.5 to 6 wt. % respectively of colloidal silica. The hydrophobised silica Aerosil® R972 is also mentioned as a suitable colloidal silica. Here again the silica acts as a thickening agent for the polyalkylene glycol and is thus dispersed in the liquid phase of the preparation.

WO 95/02724 describes detergent granules which contain an alkali metal percarbonate with an average particle size in the range 250 to 900 μm and a hydrophobic material selected from silica, talc, zeolite, DAY and hydrotalcite in a ratio by weight in the range 4:1 to 40:1. A hydrophobised silica, such as e.g. Aerosil® R972, is preferably used as the hydrophobic material. In an embodiment described for preparing the detergent preparation, the hydrophobic material is dusted onto the percarbonate particles, wherein this step is performed in a rotating drum, a mixer or a fluidised bed. The detergent granules described demonstrate improved stability of the percarbonate towards decomposition, even in the presence of builders.

WO 95/02724 discloses, on page 2, fourth paragraph, that the ratio by weight of alkali metal percarbonate to hydrophobic material described, i.e. in the range 4:1 to 40:1, is an essential feature in order to achieve improved storage stability of the percarbonate in the detergent compositions described. However, sodium percarbonate particles, onto which a hydrophobised silica has been dusted in this ratio by weight have disadvantages, compared with commercially available sodium percarbonate products which do not contain any hydrophobised silica, with regard to handling and their use in bleaches, detergents and cleansers. When handling the sodium percarbonate particles there is increased dust formation, which makes pneumatic transport of the particles and their further processing during the production of bleaches, detergents or cleansers difficult. Moreover, the sodium percarbonate particles dusted with hydrophobised silica described in WO 95/02724 are also more difficult to disperse in water and tend to form clumps and deposit the added hydrophobised silica on the surface of the water. The use of these sodium percarbonate particles in bleaches, detergents and cleansers thus leads to an impairment of the application properties of these agents.

The object of the invention was, therefore, the provision of sodium percarbonate particles which have a high storage stability in the presence of builders and at the same time can be handled and stored without the formation of dust and without caking of the particles. The sodium percarbonate particles must also permit ready dispersion in water without leaving any residues so that when they are used in bleaches, detergents and cleansers there is no impairment of the application properties of these agents.

Surprisingly, it has now been found that this object can be achieved by sodium percarbonate particles which have only 0.01 to 1 wt. %, and preferably only 0.1 to 0.5 wt. %, of a hydrophobised finely divided oxide on their surface.

The present invention provides sodium percarbonate particles, characterised in that they have on their surface 0.01 to 1 wt. %, preferably 0.1 to 0.5 wt. %, of a hydrophobised finely divided oxide of the elements silicon, aluminium or titanium or a mixed oxide of these elements, wherein the hydrophobised finely divided oxide is preferably a hydrophobised pyrogenic or precipitated silica.

The invention also includes a process for producing these sodium percarbonate particles, characterised in that sodium percarbonate particles which have optionally one or more coatings are mixed with 0.01 to 1 wt. %, preferably 0.1 to 0.5 wt. % of a hydrophobised finely divided oxide of the elements silicon, aluminium or titanium or a mixed oxide of these elements, wherein the sodium percarbonate particles used are preferably mixed with the hydrophobised finely divided oxide in the dry state.

Finally, the invention includes the use of the sodium percarbonate particles according to the invention as a bleaching component in a bleach, detergent or cleanser.

Sodium percarbonate particles according to the invention contain, on their surface, 0.01 to 1 wt. %, preferably 0.1 to 0.5 wt. %, of a hydrophobised finely divided oxide of the elements silicon, aluminium or titanium or a mixed oxide of these elements. They preferably contain a hydrophobised pyrogenic or precipitated silica as the hydrophobised finely divided oxide.

Suitable finely divided oxides are, for example, pyrogenic oxides which are obtained by the flame hydrolysis of volatile compounds of the elements silicon, aluminium or titanium or of mixtures of these compounds. The pyrogenic oxides or mixed oxides obtainable in this way preferably have an average primary particle size of less than 50 nm and may be aggregated to give larger particles having average particle sizes of preferably less than 20 μm.

Also suitable are precipitated oxides which have been precipitated from aqueous solutions of compounds of the elements silicon, aluminium or titanium or mixtures of these compounds. The precipitated oxides or mixed oxides may also contain, in addition to silicon, aluminium and titanium, small amounts of alkali metal or alkaline earth metal ions. The average particle size of the precipitated oxides is preferably less than 50 μm and particularly preferably less than 20 μm.

Hydrophobised oxides in the context of the invention are oxides which have organic groupings bonded at their surface via chemical compounds and are not wetted by water. Hydrophobised oxides may be prepared, for example, by reacting pyrogenic or precipitated oxides with organosilanes, silazanes or polysiloxanes. Silicon compounds which are suitable for the preparation of hydrophobised oxides are disclosed in EP-A 0 722 992, page 3, line 9 to page 6, line 6. Hydrophobised oxides which have been prepared by reacting a finely divided oxide with a silicon compound from the compound classes (a) to (e) and (k) to (m) specified in EP-A 0 722 992 are particularly preferred. The hydrophobised finely divided oxides preferably have a methanol wettability of at least 40.

Sodium percarbonate particles according to the invention preferably have an average particle size in the range 0.2 to 5 mm and particularly preferably in the range 0.5 to 2 mm. Sodium percarbonate particles with a low proportion of fine particles are preferred, preferably those with a proportion of less than 10 wt. % of particles smaller than 0.2 mm and particularly preferably less than 10 wt. % of particles with a particle size less than 0.3 mm.

Sodium percarbonate particles according to the invention preferably have a substantially spherical shape with a smooth surface. Particles with a smooth surface have a surface roughness of less than 10% of the particle diameter and preferably of less than 5% of the particle diameter.

Sodium percarbonate particles according to the invention may be prepared from sodium percarbonate particles which have been produced by one of the known methods of preparation of sodium percarbonate. A suitable method of preparation of sodium percarbonate is the crystallisation of sodium percarbonate from aqueous solutions of hydrogen peroxide and sodium carbonate, wherein crystallisation may be performed either in the presence of or in the absence of a salting out agent, reference being made, by way of example, to EP-A 0 703 190. Also suitable is fluidised bed spray granulation by spraying aqueous hydrogen peroxide solution and aqueous soda solution onto sodium percarbonate seeds in a fluidised bed with simultaneous evaporation of water, reference being made, by way of example, to WO 95/06615. Furthermore, the reaction of solid sodium carbonate with an aqueous hydrogen peroxide solution, followed by drying, is also a suitable method of preparation. The sodium percarbonate particles prepared by one of these processes consist substantially of sodium carbonate perhydrate with the composition 2Na₂CO₃.3H₂O₂. In addition, they may also contain small amounts of known stabilisers for peracid compounds such as e.g. magnesium salts, silicates, phosphates and/or chelating agents. Percarbonate particles prepared by the crystallisation process in the presence of a salting out agent may also contain a small amount of the salting out agent used, such as e.g. sodium chloride. Sodium percarbonate particles according to the invention are preferably prepared from sodium percarbonate particles which have been obtained by fluidised bed spray granulation.

In a preferred embodiment of the invention, the sodium percarbonate particles have an additional coating on a core of sodium percarbonate, the coating containing one or more inorganic hydrate-forming salts as the main constituent. The inorganic hydrate-forming salt(s) are preferably chosen from the set sodium sulfate, sodium carbonate, sodium hydrogen carbonate or magnesium sulfate as well as mixtures of these compounds and/or mixed salts of these compounds. Sodium sulfate is particularly preferred as the inorganic hydrate-forming salt. In a preferred embodiment, the coating consists substantially of sodium sulfate. The proportion of this coating on the sodium percarbonate particles is preferably in the range 1 to 20 wt. % and particularly preferably in the range 2 to 10 wt. %, calculated as the non-hydrated form of the hydrate-forming salt (s).

Coating the sodium percarbonate particles is performed in a manner known per se. In principle, the particles to be coated are placed in contact as uniformly as possible, once or several times, with a solution which contains one or more coating components and dried either at the same time or subsequently. For example, contact may be made on a granulating table or in a mixer such as a tumble mixer. Coating is preferably performed by fluidised bed coating, wherein an aqueous solution of the inorganic hydrate-forming salt(s) is sprayed onto the sodium percarbonate particles, or sodium percarbonate particles which have been coated with one or several layers, located in a fluidised bed and simultaneously dried with the fluidised bed gas. The fluidised bed gas may be any gas, in particular air, air with a CO₂ content in the range, for example, of 0.1 to about 15%, directly heated with a combustion gas, pure CO₂, nitrogen and inert gases. The coating is particularly preferably applied using the process described in EP-A 0 970 917.

The coating of inorganic hydrate-forming salts is preferably applied in such a way that it completely surrounds the core of sodium percarbonate. When applying the coating in the form of an aqueous solution, a boundary region may be formed at the boundary between the core material and the coating material due to dissolution of the sodium percarbonate particles during the coating process and this region may contain other compounds, in addition to sodium percarbonate and the coating material. Thus, the boundary region formed when applying a coating of substantially sodium sulfate may contain sodium hydrogen carbonate as well as double salts of sodium hydrogen carbonate and sodium sulfate such as sesquicarbonate or Wegscheider's salt, in addition to sodium percarbonate and sodium sulfate.

The coating of inorganic hydrate-forming salts may be applied directly to the core of sodium percarbonate or may be applied on top of one or more further coatings. In addition, it may be overlaid by one or more further coatings.

In another preferred embodiment, the sodium percarbonate particles have a second coating on top of a coating containing inorganic hydrate-forming salts, this second coating containing an alkali metal silicate with a modulus of SiO₂ to M₂O (M=alkali metal) greater than 2.5 as the main component. The second coating particularly preferably consists substantially of alkali metal silicate. An alkali metal silicate is understood to be any alkali metal silicates which produce, on average, the modulus mentioned above. The modulus is the molar ratio of SiO₂ to M₂O, wherein M stands for an alkali metal and is preferably lithium, sodium or potassium or a mixture of these alkali metals. Sodium silicate is particularly preferred. The modulus of the alkali metal silicate is preferably in the range 3 to 5 and is particularly preferably in the range 3.2 to 4.2. The proportion of the second coating on the sodium percarbonate particles is preferably in the range 0.2 to 3 wt. %.

The second coating is preferably applied by spraying on an alkali metal silicate-containing aqueous solution, wherein an aqueous solution with a concentration of alkali metal silicate in the range 2 to 20 wt. % is preferably used, particularly preferably 3 to 15 wt. % and in particular 5 to 10 wt. %. A so-called water glass solution is preferably sprayed on in order to apply a coating of substantially sodium silicate.

When compared with comparable sodium percarbonate particles which do not have any hydrophobised finely divided oxide at the surface, sodium percarbonate particles according to the invention have improved storage stability in the presence of builders, in particular in the presence of siliceous builders such as e.g. zeolites. When stabilising sodium percarbonate particles by the use of a coating of an inorganic hydrate-forming salt, the same storage stability can be achieved in the case of the sodium percarbonate particles according to the invention by using a substantially smaller amount of coating than in the case of comparable particles which do not have any hydrophobised finely divided oxide at the surface. Thus, for example, when using a coating of sodium sulfate in the case of sodium percarbonate particles according to the invention, the same stabilities are achieved with an amount of 2 wt. % of coating as are produced in the case of sodium percarbonate particles without hydrophobised finely divided oxide at the surface only with an amount of coating of 6 wt. %. Sodium percarbonate particles according to the invention with a coating of an inorganic hydrate-forming salt can therefore be produced with a higher active oxygen content while having the same storage stability.

Sodium percarbonate particles according to the invention also have a reduced tendency to cake when compared with particles which do not have any hydrophobised finely divide oxide at the surface, in particular during storage when subjected to pressure. Sodium percarbonate particles according to the invention are therefore readily siloable, i.e. they can be stored in silos for long periods and exhibit good flow behaviour without the formation of clumps or caking in the silo, even after long periods of storage in the silo. The advantage of a reduced tendency to cake is expressed in particular in the case of sodium percarbonate particles according to the invention which have a second coating containing an alkali metal silicate as the main component, on top of an inorganic hydrate-forming salt-containing coating.

Sodium percarbonate particles according to the invention demonstrate much less dust formation during handling, when compared with the particles disclosed in WO 95/02724 with a ratio by weight of alkali metal percarbonate to hydrophobic material in the range 4:1 to 40:1, because the hydrophobised finely divided oxide in the sodium percarbonate particles according to the invention, surprisingly, adheres firmly to the surface of the sodium percarbonate particles and barely contributes at all to abrasion and dust formation. In contrast to the particles disclosed in WO 95/02724, sodium percarbonate particles according to the invention can therefore be transported by a pneumatic means without this leading to dust formation and increased abrasion or to the demixing of sodium percarbonate and hydrophobised finely divided oxide. In contrast to the alkali metal percarbonate particles disclosed in WO 95/02724, sodium percarbonate particles according to the invention exhibit virtually no disadvantages with regard to dispersibility in water when compared with sodium percarbonate particles which do not have any hydrophobised finely divided oxide at the surface. Sodium percarbonate particles according to the invention dissolve in water just as rapidly as sodium percarbonate particles which do not contain any hydrophobised finely divided oxide and, when dissolved in water in the amounts conventionally used in bleaches, detergents and cleansers, do not lead to troublesome deposits of the hydrophobised finely divided oxide.

The invention also provides a process for preparing the sodium percarbonate particles according to the invention, in which sodium percarbonate particles, which optionally have one or more coatings, are mixed with 0.01 to 1 wt. % and preferably 0.1 to 0.5 wt. % of a hydrophobised finely divided oxide of the elements silicon, aluminium, or titanium or a mixed oxide of these elements. A hydrophobised pyrogenic or precipitated silica is preferably used as the hydrophobised finely divided oxide.

The sodium percarbonate particles used preferably have an average particle size in the range 0.2 to 5 mm and particularly preferably in the range 0.5 to 2 mm. The hydrophobised finely divided oxide preferably has an average particle size of less than 20 μm. The ratio of the average particle size of the sodium percarbonate particles used to the average particle size of the hydrophobised finely divided oxide used is preferably greater than 20 and particularly preferably greater than 50.

The sodium percarbonate particles used are preferably mixed with the hydrophobised finely divided oxide in the dry state. The mixing process may be performed in any apparatus suitable for the mixing of solids. The sodium percarbonate particles for mixing with the hydrophobised finely divided oxide are preferably dispersed in a gas phase. The mixing process may be performed in this preferred embodiment of the process, for example, in a fluidised bed, in a falling tube or in an entrained-bed conveyer.

Surprisingly, even in the case of dry mixing of the sodium percarbonate particles with 0.01 to 1 wt. % of the hydrophobised finely divided oxide, the hydrophobised finely divided oxide is virtually completely bonded at the surface of the sodium percarbonate particles used so that the finely divided oxide used barely contributes at all to the fine-grained fraction or to dust formation in the product obtained.

Mixing the sodium percarbonate particles used with the hydrophobised finely divided oxide in a falling tube or in an entrained-bed conveyer enables, in a simple manner, continuous preparation of the sodium percarbonate particles according to the invention and does not require any mixing devices with additional moving parts. Continuous mixing in a falling tube or an entrained-bed conveyer facilitates the production of a particularly homogeneous product in which substantially all the sodium percarbonate particles have the proportion by weight according to the invention of a hydrophobised finely divided oxide on their surface.

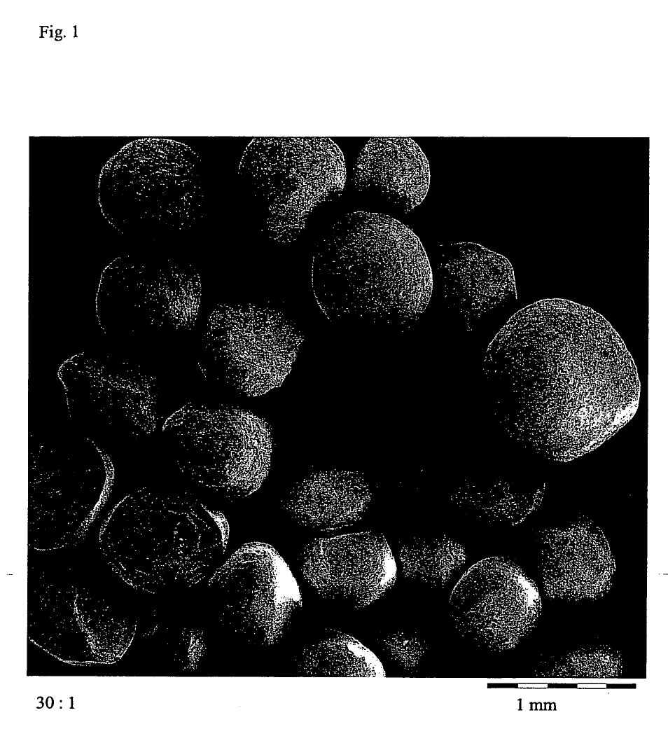

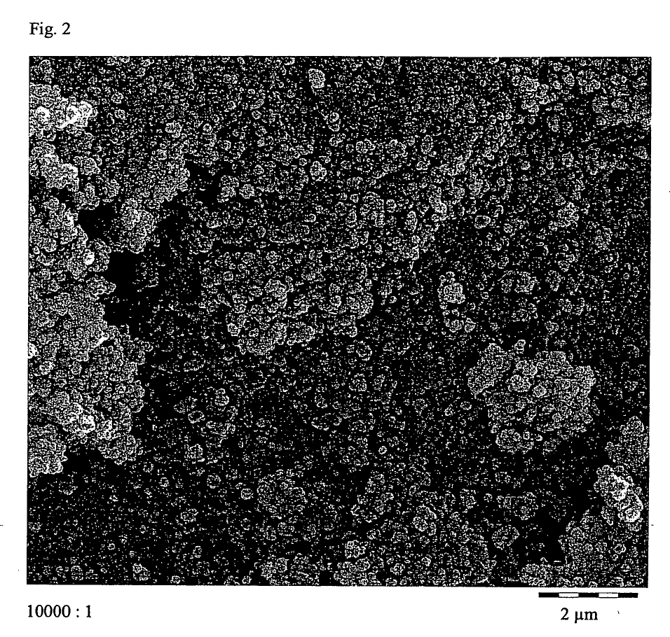

FIGS. 1 and 2 show scanning electron microscope images of sodium percarbonate particles according to the invention with a coating of 6 wt. % of sodium sulfate and which contain 0.5 wt. % of the hydrophobised silica Aerosil® R812 on the surface. The particles were prepared by fluidised bed spray granulation, then coated by spraying on sodium sulfate solution in a fluidised bed with the evaporation of water followed by dry mixing of the coated particles with the hydrophobised silica in a tumble mixer. The figures show that the hydrophobised silica adheres virtually completely to the surface of the sodium percarbonate particles in the particles according to the invention.

Another object of the invention is directed towards the use of sodium percarbonate particles according to the invention as bleach-active components in detergents, bleaches or cleansers. The detergents, bleaches or cleansers are in particular those which contain at least one builder and preferably a siliceous builder. Builders are understood to be any soluble or insoluble compounds which are able to sequestrate or to form a complex with calcium and/or magnesium ions in the water being used during use of the detergent, bleach or cleanser. Examples of siliceous builders are soluble silicates, insoluble sheet silicates and zeolites, in particular zeolite A and zeolite X.

Sodium percarbonate particles according to the invention are preferably used in detergents, bleaches or cleansers in an amount of 5 to 50 wt. %, particularly preferably 10 to 40 wt. % and in particular 15 to 20 wt. %. The detergents, bleaches and cleansers may contain, in addition to the sodium percarbonate particles according to the invention, other constituents, in particular
one or more surfactants, preferably chosen from the set of cationic, anionic, non-ionic and amphoteric surfactants,
one or more inorganic and/or organic builders, preferably chosen from the set of zeolites, sheet silicates, soluble silicates, polyphosphates, amino polyacetic acids, amino polyphosphonic acids and polyoxycarboxylic acids,
one or more alkaline components, preferably chosen from the set of alkali metal carbonates, alkali metal silicates and alkanolamines,
one or more bleach activators, preferably chosen from the set of N-acyl compounds and O-acyl compounds such as, for example, tetraacetyl ethylene diamine (TAED) or nonanoyl oxybenzene sulfonate (NOBS),
one or more enzymes, preferably chosen from the set of lipases, cutinases, amylases, proteases, esterases, cellulases, pectinases, lactases and peroxidases and
one or more auxiliary substances, preferably chosen from the set of peroxide stabilisers, antiredeposition agents, optical brighteners, foam inhibitors, disinfectants, corrosion inhibitors, fragrances and colorants.

By using sodium percarbonate particles according to the invention as bleach-active components in detergents, bleaches or cleansers, the storage stability of these agents can be improved and the loss of active oxygen during storage of the agents can be reduced.

### EXAMPLES

The sodium percarbonate used in the examples for preparing sodium percarbonate particles according to the invention was produced by fluidised bed build-up granulation using the method described in WO 95/06615. The sodium percarbonate particles used had an average particle size of 0.65 mm and contained virtually no particles with a diameter less than 0.3 mm. Sodium percarbonate particles with a coating of 2 wt. % of sodium sulfate were prepared therefrom in a laboratory apparatus by spraying with aqueous sodium sulfate solution and simultaneously evaporating off the water. Sodium percarbonate particles with a coating of 6 wt. % of sodium sulfate were prepared by spraying with an aqueous sodium sulfate solution using the process described in EP-A 0 670 917.

To produce sodium percarbonate particles according to the invention, -the sodium percarbonate used was mixed with-the amounts and types of finely divided silica listed in tables 1 to 3 and table 5 for 30 minutes in a tumble mixer. The finely divided silicas used had the following properties:
Aerosil® R812: pyrogenic silica, hydrophobised with hexamethyldisilazane, BET specific surface area 260 m²/g, average primary particle size 7 nm, methanol wettability 50
Aerosil® R972: pyrogenic silica, hydrophobised with dimethyldichlorosilane, BET specific surface area 110 m²/g, average primary particle size 16 nm, methanol wettability 35
Aerosil® 200: pyrogenic silica, not modified, BET specific surface area 200 m²/g, average primary particle size 12 nm
Sipernat® D17: precipitated silica, hydrophobised, BET specific surface area 100 m²/g, average particle size 7.0 μm, methanol wettability 55
Sipernat® 22S: precipitated silica, not modified, BET specific surface area 190 m²/g, average particle size 7.0 μm

To determine the storage stability in the presence of zeolitic builders, 15 g of the product obtained were mixed with 15 g of zeolite A (Zeocros CG 180) and stored uncovered for 68 hours at 38° C. and 75% relative humidity, in a climatised cabinet. The active oxygen content was determined before and after storage by manganometric titration and the active oxygen content during storage (rel. residual Oa) was calculated therefrom. The test results are summarised in tables 1 to 3 and show that sodium percarbonate particles according to the invention have much better storage stability in the presence of zeolitic builders than sodium percarbonate particles which do not have any finely divided oxide or have a finely divided hydrophilic silica such as Aerosil® 200 or Sipernat® 22S on their surface.

TABLE 1
Storage stability of sodium percarbonate without
a coating in the presence of zeolite A

| | Finely | Amount of finely | |
|---|---|---|---|
| | divided | divided oxide in | Rel. residual |
| Example | oxide | wt. % | Oa as a %-age |
| 1* | none | | 77 |
| 2* | Aerosil R812 | 0.1 | 87 |
| 3 | Aerosil R812 | 0.2 | 89 |
| 4 | Aerosil R812 | 0.3 | 90 |
| 5* | Aerosil 200 | 0.3 | 81 |

*Example not according to the invention

TABLE 2
Storage stability of sodium percarbonate with a
coating of 2 wt. % Na₂SO₄ in the presence of zeolite A

| | Finely | Amount of finely | |
|---|---|---|---|
| | divided | divided oxide in | Rel. residual |
| Example | oxide | wt. % | Oa as a %-age |
| 6* | none | | 80 |
| 7 | Aerosil R812 | 0.05 | 82 |
| 8 | Aerosil R812 | 0.1 | 89 |
| 9 | Aerosil R812 | 0.2 | 90 |
| 10 | Aerosil R812 | 0.3 | 89 |
| 11 | Aerosil R972 | 0.3 | 90 |
| 12* | Aerosil R200 | 0.3 | 80 |
| 13 | Sipernat D17 | 0.3 | 91 |
| 14* | Sipernat 22S | 0.3 | 82 |

*Example not according to the invention

TABLE 3
Storage stability of sodium percarbonate with a
coating of 6 wt. % Na₂SO₄ in the presence of zeolite A

| | Finely | Amount of finely | |
|---|---|---|---|
| | divided | divided oxide in | Rel. residual |
| Example | oxide | wt. % | Oa as a %-age |
| 15* | none | | 85 |
| 16 | Aerosil R812 | 0.1 | 90 |
| 17 | Aerosil R812 | 0.3 | 95 |
| 18 | Aerosil R972 | 0.1 | 89 |
| 19* | Aerosil R972 | 2.5 | 91 |

*Example not according to the invention

Table 4 gives the active oxygen contents and the handling characteristics, here dissolution time and abrasion, for some of the sodium percarbonate particles prepared. The active oxygen contents were determined by manganometric titration. The dissolution time was determined conductometrically as the time after which 90% of the final value for the conductivity was reached, when dissolving 2.5 g of product per litre of water at 20° C. with stirring. The abrasion was determined as described in ISO 5937. The product from examples 6, 10, 16 and 18 showed no tendency to clump together and resulted in clear solutions when determining the dissolution time. The product from example 19 clumped together when determining the dissolution time and demonstrated, even after complete dissolution of the sodium percarbonate, a visible deposit of the hydrophobic silica on the surface of the solution.

TABLE 4
Active oxygen content and handling
characteristics of sodium percarbonate particles

| | Active oxygen | Dissolution | Abrasion in |
|---|---|---|---|
| Example | content in wt. % | time in min | wt. % |
| 6* | 14.17 | 1.5 | 3.4 |
| 10 | 14.14 | 1.5 | 3.2 |
| 16 | 13.59 | 1.4 | |
| 18 | 13.35 | 1.05 | 1.2 |
| 19* | 13.36 | 6.1 | 4.2 |

*Example not according to the invention

It is obvious from the data in table 4 that the sodium percarbonate particles according to the invention (example 10) do not differ from comparable sodium percarbonate particles (example 6) which do not have any finely divided oxide at the surface, with regard to dissolution in water and dust formation due to abrasion. A product prepared in accordance with WO 95/02724 (example 19), however, exhibited much more dust formation due to abrasion and a prolonged dissolution time, wherein the particles clumped together during dissolution, and even after dissolution of the sodium percarbonate, undesirable deposits of the silica present in the product occurred.

Table 5 shows the particle size distributions, determined by sieve analysis, of the samples from examples 6 and 10, wherein the sample from example 10 differed from the sample from example 6 only by the application of 0.3 wt. % of Aerosil® R812. The lack of fine particles in the range less than 0.3 mm showed that the Aerosil® applied adhered to the surface of the sodium percarbonate particles.

TABLE 5
Sieve analysis of sodium percarbonate particles

| | Proportion of granular fraction in | |
|---|---|---|
| Granular fraction | wt.% | |
| in mm | Example 6* | Example 10 |
| Less than 0.1 | 0 | 0 |
| 0.1-0.2 | 0.1 | 0 |
| 0.2-0.3 | 0.1 | 0 |
| 0.3-0.4 | 2.3 | 1.8 |
| 0.4-0.5 | 24.4 | 16.1 |
| 0.5-0.6 | 22.8 | 21.0 |
| 0.6-0.7 | 22.9 | 25.7 |
| 0.7-0.8 | 11.6 | 14.4 |
| 0.8-1.0 | 10.6 | 14.0 |
| 1.0-1.25 | 4.5 | 6.0 |
| 1.25-1.4 | 0.6 | 0.7 |
| 1.4-1.6 | 0.2 | 0.2 |
| greater than 1.6 | 0 | 0.1 |

*Example not according to the invention

Using samples from examples 15, 18 and 19, the siloability was also determined by measuring Jenike's time-compaction behaviour, as is described in EP-B 863 842 on page 5, lines 20 to 38. The flowability index ffc is a measure of the flowability of the material after storage when subjected to pressure, as occurs during storage in a silo. Materials with a higher flowability index ffc exhibit less time-compaction and less caking and are also free-flowing after a longer period of storage in a silo. The results given in table 6 show that the sodium percarbonate particles according to the invention (example 18) have less time-compaction and thus improved flowability and siloability, than sodium percarbonate particles (example 15) which do not have any finely divided oxide at the surface, while a product prepared in accordance with WO 95/02724 (example 19) has a high time-compaction and thus impaired flowability and siloability.

TABLE 6
time-compaction behaviour of sodium percarbonate
particles

| | Jenike's flowability index ffc | | |
|---|---|---|---|
| Example | no storage | after 1 day | after 7 days |
| 15* | 77 | 15 | 15 |
| 18 | 61 | 23 | 23 |
| 19* | 19 | 9.3 | 7.7 |

*Example not according to the invention

Table 7 gives the results of climate tests for determining the storage stability of sodium percarbonate in a commercially available universal detergent. In the climate test, the sodium percarbonate is mixed with a phosphate-free, zeolite-containing detergent powder and also with the activator TAED in an amount such that the mixture contains 5 wt. % TAED and the active oxygen content of the mixture is about 2.35 wt. %. The detergent powder contains, as constituents (in wt. %),

| | |
|---|---|
| anionic surfactants | 12 |
| non-ionic surfactants | 8 |
| zeolite A | 36 |
| soda | 10 |
| sodium silicate | 3 |
| remainder (inc. moisture) | 31 |

800 g of the mixture are stored in commercially available, water-repellent impregnated and glued El detergent packets at 35° C. and 80% relative humidity in a climatised cabinet. One packet is taken out after 4 and another after 8 weeks and the active oxygen content is determined manganometrically in the conventional manner. The relative residual Oa is determined after 4 and 8 weeks respectively, using the Oa content determined and the initial Oa content.

Example 20 was performed with a sodium percarbonate which had a coating of 6 wt. % of sodium sulfate and a particle size greater than 0.4 mm. Example 21 was designed with sodium percarbonate particles according to the invention in which, as described above, 0.5 wt. % of the hydrophobised silica Aerosil® R812 had been applied to the sodium percarbonate particles in example 20.

TABLE 7
Storage stability of sodium percarbonate in a
universal detergent

| | | Rel. resid. | Rel resid. Oa |
|---|---|---|---|
| | Finely | Oa after 4 | after 8 weeks |
| Example | divided oxide | weeks in % | in % |
| 20* | none | 95 | 86 |
| 21 | 0.5 wt. % | 98 | 88 |
| | Aerosil R812 | | |

*Example not according to the invention

The results in table 7 show that the sodium percarbonate particles according to the invention, when compared with sodium percarbonate which does not have any finely divided hydrophobised oxide at the surface, leads to a reduced loss in active oxygen content during storage of the detergent, when used as a bleaching component in a detergent.

1-17. (canceled)

18. Sodium percarbonate particles, comprising on their surface 0.01 to 1 wt% of a hydrophobised finely divided oxide of the elements Si, Al or Ti or a mixed oxide of these elements.

19. The sodium percarbonate particles of claim 18, wherein said hydrophobised finely divided oxide is a hydrophobised pyrogenic or precipitated silica.

20. The sodium percarbonate particles of claim 18, wherein said hydrophobised finely divided oxide has an average particle size of less than 20 μm.

21. The sodium percarbonate particles of claim 18, wherein said sodium percarbonate particles have an average particle size in the range of from 0.2 to 5 mm.

22. The sodium percarbonate particles of claim 18, wherein said sodium percarbonate particles have an essentially spherical shape with a smooth surface.

23. The sodium percarbonate particles of claim 18, wherein said sodium percarbonate particles have been prepared by fluidised bed spray granulation.

24. The sodium percarbonate particles of claim 18, wherein each sodium percarbonate particle is surrounded by a coating, said coating comprising one or more hydrate-forming inorganic salts as the main component(s) on a core of sodium percarbonate.

25. The sodium percarbonate particles of claim 24, wherein said one or more hydrate-forming inorganic salts are selected from the group consisting of: sodium sulfate; sodium carbonate; sodium hydrogen carbonate; and magnesium sulfate; as well as mixed salts of these compounds.

26. The sodium percarbonate particles of claim 24, wherein said coating, calculated as the non-hydrated form of said hydrate-forming inorganic salt(s), makes up from 1 to 20 wt % of said sodium percarbonate particles.

27. The sodium percarbonate particles of claim 24, further comprising a second coating over said coating comprising hydrate-forming inorganic salts, said second coating comprising as its main component an alkali metal silicate with a modulus SiO₂ to M₂O (M=alkali metal) of greater than 2.5.

28. The sodium percarbonate particles of claim 27, wherein said second coating is prepared by spraying on an aqueous solution comprising said alkali metal silicate with an alkali metal silicate content of 2 to 20 wt %.

29. A process for producing the sodium percarbonate particles of claim 18, comprising mixing sodium percarbonate particles, optionally having one or more coatings, with 0.01 to 1 wt % of a hydrophobised finely divided oxide of the elements Si, Al or Ti or a mixed oxide of these elements.

30. The process of claim 29, wherein said sodium percarbonate particles are mixed with said hydrophobised finely divided oxide in the dry state.

31. The process of claim 29, wherein said sodium percarbonate particles have an average particle size in the range of from 0.2 to 5 mm, and said hydrophobised finely divided oxide has an average particle size of less than 20 μm.

32. The process of claim 29, wherein said sodium percarbonate particles are dispersed in a gas phase for mixing with said hydrophobised finely divided oxide.

33. The process of claim 32, wherein said hydrophobised finely divided oxide is mixed with said sodium percarbonate particles in a falling tube or in an entrained-bed conveyer.

34. A detergent composition comprising the sodium percarbonate particles of claim 18 as a bleaching component.

35. A cleanser composition comprising the sodium percarbonate particles of claim 18 as a bleaching component.

36. A bleach composition comprising the sodium percarbonate particles of claim 18 as a bleaching component.
